(19) United States
(12) Patent Application Publication
(10) Pub. No.: US 2026/0070007 A1
(43) Pub. Date: Mar. 12, 2026

(54) TOOL-FREE WATER FILTER

(71) Applicant: KEMFLO INTERNATIONAL CO., LTD., Pingtung City (TW)

(72) Inventors: Sheng-Nan Lin, Pingtung City (TW); Ming-Chung Lin, Pingtung City (TW)

(21) Appl. No.: 18/883,718

(22) Filed: Sep. 12, 2024

(51) Int. Cl. B01D 29/96; B01D 35/147; B01D 35/30

(52) U.S. Cl. CPC B01D 29/96; B01D 35/1475; B01D 35/306; B01D 2201/165; B01D 2201/302; B01D 2201/4084

(57) ABSTRACT

A water filter includes a filtering head, a filter bottle assembly, a filter element, a switching device, and a quick release device. The filtering head has a water inlet, a water outlet, and multiple embedded slots. The filter bottle assembly includes a filter bottle removably mounted on the filtering head. The filter element is mounted in the filter bottle and provided with a flow channel. The switching device is mounted on the filtering head and includes a handle and a control shaft provided with a connecting hole. The quick release device includes multiple movable modules mounted in the embedded slots, a push member mounted on the filter bottle, and a snap-fit member mounted on the push member. In assembly, the movable modules are positioned between the push member and the snap-fit member so that the filter bottle is locked on the filtering head.

### BACKGROUND OF THE INVENTION

### Field of the Invention

The present invention relates to a water filter and, more particularly, to a tool-free water filter.

### Description of the Related Art

A conventional water filter or purifier has a POE (point of entry) filtering mode and comprises a filtering head and a filter bottle. The filter bottle contains a filter element and is connected with the filtering head. When the user wishes to replace the filter element, the water source has to be shut previously, and the filter bottle is rotated by a wrench to detach the filter bottle from the filtering head. However, the water easily leaks outward during replacement of the filter element if the user forgets to shut the water source. In addition, when the filter bottle is rotated by the wrench to an excess extent, the filter bottle easily falls after being detached from the filtering head, thereby causing danger to the user. Another conventional water filter further comprises a cam sliding rail (or track) which is rotated to mount or detach the filter bottle. However, the cam sliding rail has a complicated structure and is exposed from the filtering head so that the cam sliding rail is easily hooked or torn by the user. In addition, the filter bottle easily falls down after being detached from the filtering head.

### BRIEF SUMMARY OF THE INVENTION

The primary objective of the present invention is to provide a water filter whose filter bottle is assembled and disassembled easily and rapidly.

In accordance with the present invention, there is provided a water filter comprising a filtering head, a filter bottle assembly, a filter element, a switching device, and a quick release device. The filtering head has a first end and a second end. The first end is provided with a water inlet and a water outlet connected to the water inlet. The second end is provided with multiple embedded slots. The filter bottle assembly includes a filter bottle removably mounted on a lower portion of the filtering head. The filter bottle has an upper end provided with a first locking portion and a stop block located under the first locking portion. The stop block rests on the second end. The filter element is mounted in the filter bottle and provided with a flow channel. The switching device is mounted on the first end of the filtering head. The switching device includes a handle and a control shaft connected with the handle. The control shaft is provided with a connecting hole which is a valve port penetrating the control shaft. The control shaft is rotated with the handle synchronously. The control shaft and the handle are rotated in the same direction. The quick release device includes multiple movable modules, a push member, and a snap-fit member. The movable modules are mounted in the embedded slots respectively. The movable modules elastically extend into and are reciprocally moved in the embedded slots. The push member has an exterior provided with a stop portion and a mounting portion. The mounting portion is a mounting ring. The push member has an interior provided with a second locking portion locked onto the first locking portion of the filter bottle. The snap-fit member is slidably mounted on the mounting portion and is spaced from the stop portion. when the handle is rotated, the control shaft is rotated between a water purifying mode and a by-pass mode. When the control shaft is rotated to the water purifying mode, the connecting hole of the control shaft is connected to the water inlet and the water outlet, and is connected to the flow channel, so that ambient water flows through the water inlet, the connecting hole and the flow channel into the filter element. when the control shaft is rotated to the by-pass mode, the connecting hole of the control shaft is connected to the water inlet and the water outlet, and is disconnected from the flow channel. when the filter bottle is pushed up, the push member is moved to press the movable modules. When the push member is located above the movable modules, the movable modules are positioned between the stop portion of the push member and the snap-fit member to form a locking state therebetween, so that the filter bottle is locked on the filtering head. when the filter bottle is pushed upward to reach a top point, the snap-fit member is located above the movable modules, and when the filter bottle is quickly pulled downward after the filter bottle reaches the top point, the stop portion of the push member and the snap-fit member are moved downward simultaneously to press and pass the movable modules, so that the filter bottle is unlocked and removed from the filtering head.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a water filter in accordance with the preferred embodiment of the present invention.

FIG. 2 is a side cross-sectional view of the water filter as shown in FIG. 1.

FIG. 3 is an exploded perspective view of the water filter in accordance with the preferred embodiment of the present invention.

FIG. 4 is a perspective view of the switching device of the water filter in accordance with the preferred embodiment of the present invention.

FIG. 5 is a schematic operational view of the water filter as shown in FIG. 2.

FIG. 6 is a locally enlarged view of the water filter as shown in FIG. 5.

FIG. 6a is a side cross-sectional view showing replacement of the filter bottle of the water filter.

FIG. 6b is a schematic operational view of the water filter as shown in FIG. 6a.

FIG. 6c is a schematic operational view of the water filter as shown in FIG. 6b.

FIG. 6d is a schematic operational view of the water filter as shown in FIG. 6c.

FIG. 7a is a side cross-sectional view showing assembly of the filter bottle of the water filter.

FIG. 7b is a schematic operational view of the water filter as shown in FIG. 7a.

### DETAILED DESCRIPTION OF THE INVENTION

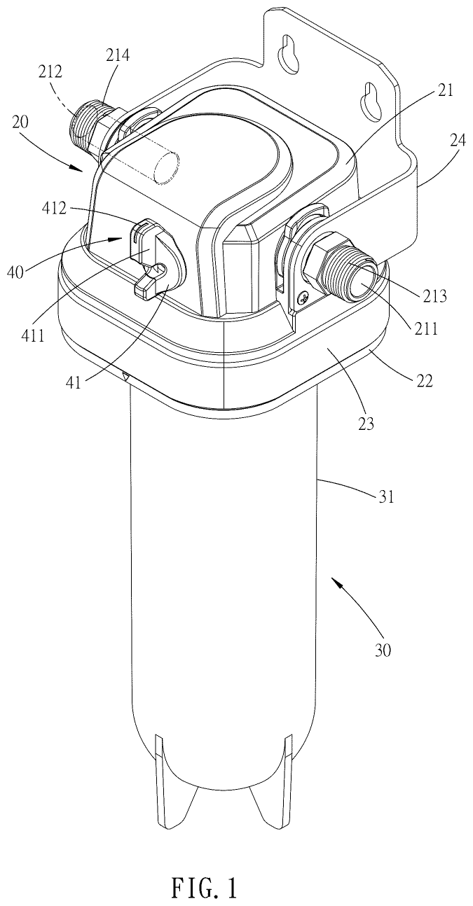

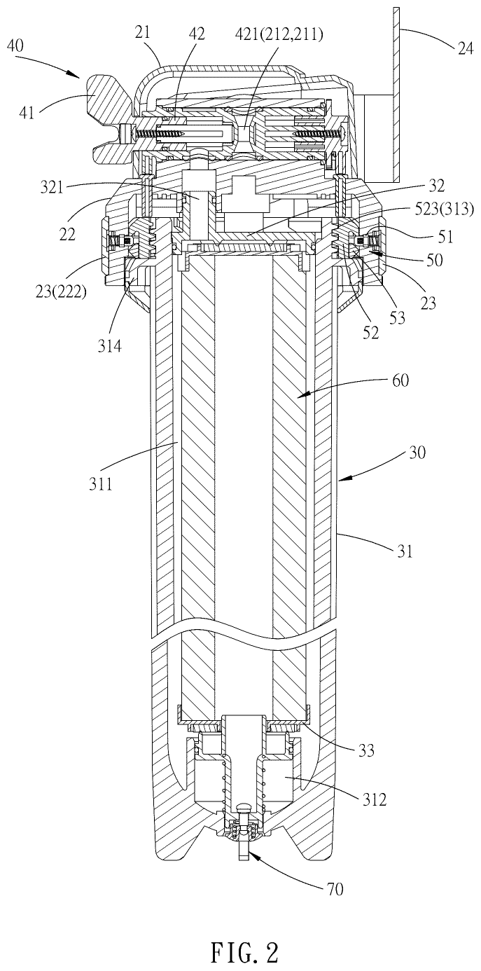

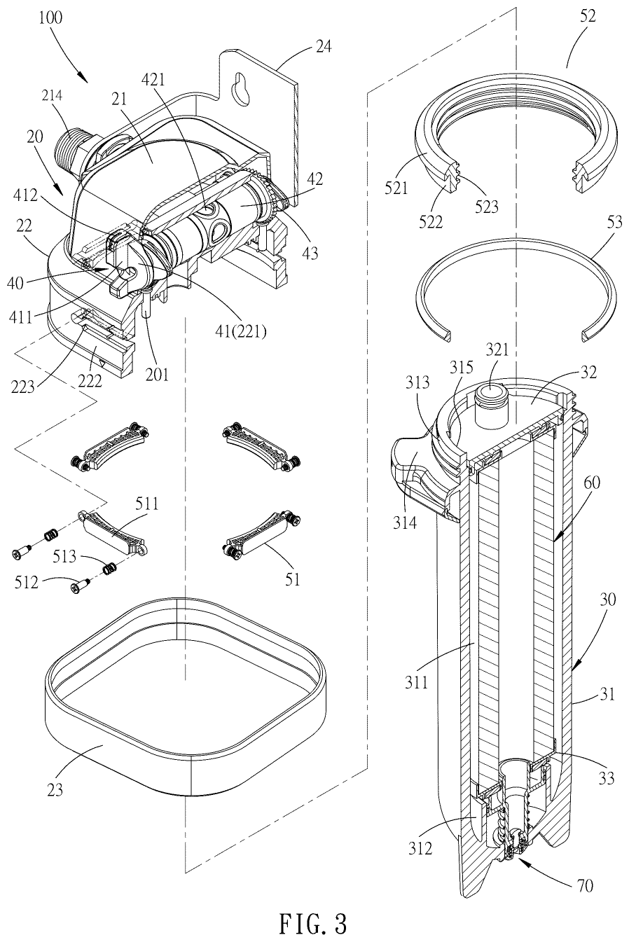

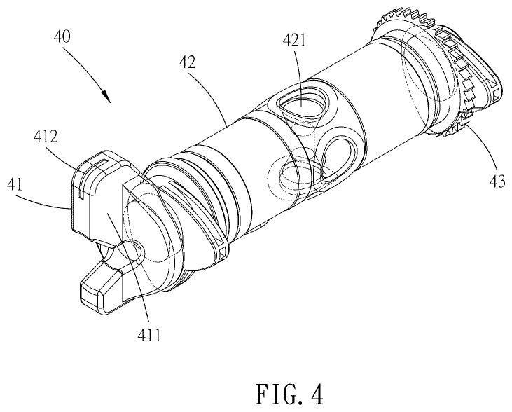

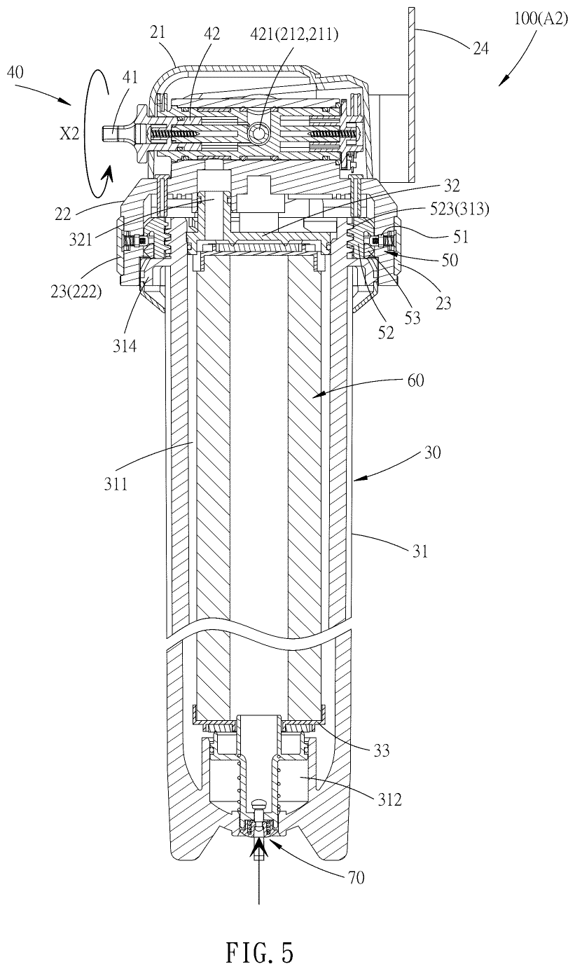

Referring to the drawings and initially to FIGS. 1-6, a water filter (or purifier) 100 in accordance with the preferred embodiment of the present invention comprises a filtering head (or housing or cover) 20, a filter bottle assembly 30, a filter element (or cartridge) 60, a switching device (or water valve assembly) 40, and a quick release device 50.

The filtering head 20 has a first end 21 and a second end 22. The first end 21 is provided with a water inlet 211 and a water outlet 212 connected to the water inlet 211. The water inlet 211 and the water outlet 212 construct a waterway (or water channel). The second end 22 is provided with multiple embedded slots 223.

The filter bottle assembly 30 includes a filter bottle (or container) 31 removably mounted on a lower portion of the filtering head 20. The filter bottle 31 has an upper end provided with a first locking portion 313 and a stop block 314 located under the first locking portion 313. The stop block 314 rests on the second end 22. The filter element 60 is mounted in the filter bottle 31 and provided with a flow channel 321.

The switching device 40 is mounted on the first end 21 of the filtering head 20. The switching device 40 includes a handle 41 and a control shaft 42 connected with the handle 41. The handle 41 is a rotary knob. The control shaft 42 is provided with a connecting hole 421 which is a valve port (or flow passage) penetrating the control shaft 42. The connecting hole 421 is disposed between the water inlet 211 and the water outlet 212 and is movable to connect the water inlet 211 and the water outlet 212. The control shaft 42 is rotated with the handle 41 synchronously. The control shaft 42 and the handle 41 are rotated in the same direction.

The quick release device 50 includes multiple movable modules 51, a push member 52, and a snap-fit member 53. The movable modules 51 are mounted in the embedded slots 223 respectively. The movable modules 51 elastically extend into and are reciprocally moved in the embedded slots 223. The push member 52 has an exterior provided with a stop portion 521 and a mounting portion 522. The mounting portion 522 is a mounting ring. The push member 52 has an interior provided with a second locking portion 523 locked onto the first locking portion 313 of the filter bottle 31. The snap-fit member 53 is slidably mounted on the mounting portion 522 and is spaced from the stop portion 521.

In practice, when the handle 41 is rotated, the control shaft 42 is rotated between a water purifying mode (or first flow path mode) A1 and a by-pass mode (or replacement mode or detachment mode or second flow path mode) A2. When the control shaft 42 is rotated to the water purifying mode A1, the connecting hole 421 of the control shaft 42 is connected to the water inlet 211 and the water outlet 212, and is connected to the flow channel 321, so that ambient water flows through the water inlet 211, the connecting hole 421 and the flow channel 321 into the filter element 60 which strains the water. Then, the purified water from the filter element 60 flows through the flow channel 321 and the connecting hole 421 into the water outlet 212 and flows outward from the water outlet 212. Alternatively, when the control shaft 42 is rotated to the by-pass mode A2, the connecting hole 421 of the control shaft 42 is connected to the water inlet 211 and the water outlet 212, and is disconnected from the flow channel 321, so that the ambient water directly flows through the water inlet 211 into the water outlet 212. Thus, the switching device 40 is used to switch two water inlet modes including the water purifying mode A1 and the by-pass mode A2.

In assembly, when the filter bottle 31 is pushed up, the push member 52 is moved to press the movable modules 51. When the push member 52 is located above the movable modules 51, the movable modules 51 are positioned between the stop portion 521 of the push member 52 and the snap-fit member 53 to form a locking state therebetween, so that the filter bottle 31 is locked on the filtering head 20. Alternatively, when the filter bottle 31 is pushed upward to reach a top point, the snap-fit member 53 is located above the movable modules 51, and when the filter bottle 31 is quickly pulled downward after the filter bottle 31 reaches the top point, the stop portion 521 of the push member 52 and the snap-fit member 53 are moved downward simultaneously to press and pass the movable modules 51, to release the locking state therebetween, so that the filter bottle 31 is unlocked and removed from the filtering head 20.

In the preferred embodiment of the present invention, a mounting bracket 24 is mounted on a rear side of the first end 21 of the filtering head 20 to hang or attach the water filter 100 to a working place, such as a wall, a table or the like.

In the preferred embodiment of the present invention, the second end 22 of the filtering head 20 has an area more than that of the first end 21 so that the filtering head 20 has a stepped shape. The second end 22 of the filtering head 20 has an exterior provided with a mounting groove 222 connected to the embedded slots 223, and a protection cover 23 is mounted in the mounting groove 222 to cover the movable modules 51 and the embedded slots 223. The mounting groove 222 has an annular shape.

In the preferred embodiment of the present invention, the filter bottle assembly 30 further includes a first positioning plate 32 mounted in the filter bottle 31, and a second positioning plate 33 mounted in the filter bottle 31 and located under and parallel with the first positioning plate 32. The flow channel 321 of the filter element 60 is formed on the first positioning plate 32. The filter bottle 31 has a first receiving space 311 defined between the first positioning plate 32 and the second positioning plate 33 and a second receiving space 312 defined between the second positioning plate 33 and a bottom of the filter bottle 31. The filter element 60 is received in the first receiving space 311 and has a top secured to the first positioning plate 32 and a bottom abutting the second positioning plate 33. A pressure relief valve 70 is mounted on the bottom of the filter bottle 31 and connected to the second receiving space 312. Thus, the pressure relief valve 70 is pressed to release the pressure in the filter bottle 31 to facilitate replacement of the filter bottle 31.

In the preferred embodiment of the present invention, the upper end of the filter bottle 31 has an interior provided with at least one gap (or breach) 315. A press rod 201 is mounted on the second end 22 of the filtering head 20 and is movable to extend into the at least one gap 315. The press rod 201 is disposed under the switching device 40. When the switching device 40 is rotated, the press rod 201 is pressed downward by the handle 41 and extends into the at least one gap 315 to press the filter bottle 31, and to provide a downward force to aid replacement of the filter bottle 31.

In the preferred embodiment of the present invention, the filtering head 20 is provided with at least one protruding block (not shown). When the filtering head 20 is rotated on the filter bottle 31 in the clockwise direction, the at least one protruding block is moved in the at least one gap 315 to form a fool-proof design.

In the preferred embodiment of the present invention, the switching device 40 further includes a ratchet mechanism 43 connected with the control shaft 42, and a drive lever (or detent) mounted on the first end 21 of the filtering head 20 and meshing with the ratchet mechanism 43 to form a one-way rotation of the control shaft 42 which is rotated in the normal (or counterclockwise) direction and stop rotating in the reverse (or clockwise) direction. The ratchet mechanism 43 has an oblique toothed face. The control shaft 42 is located between the handle 41 and the ratchet mechanism 43.

In the preferred embodiment of the present invention, the handle 41 is provided with an indication line 412 extending longitudinally. The indication line 412 and the connecting hole 421 of the control shaft 42 are directed in the same direction. In practice, the handle 41 of the switching device 40 is moved between a first positioning direction (or angle) X1 where the indication line 412 and the connecting hole 421 are directed in a longitudinal and vertical direction and a second positioning direction (or angle) X2 where the indication line 412 and the connecting hole 421 are directed in a transverse and horizontal direction. When the handle 41 of the switching device 40 is moved to the first positioning direction X1, the control shaft 42 is rotated to reach the water purifying mode A1, and when the handle 41 of the switching device 40 is moved to the second positioning direction X2, the control shaft 42 is rotated to reach the by-pass mode A2.

In the preferred embodiment of the present invention, the rotation angle of the first positioning direction X1 is 0 □, and the rotation angle of the second positioning direction X2 is 90 □ or 270 □.

In the preferred embodiment of the present invention, the handle 41 is provided with a grip 411, and the indication line 412 is formed on the grip 411.

In the preferred embodiment of the present invention, each of the movable modules 51 includes a press piece 511, two springs 513, and two fastening members 512. The press piece 511 is movably mounted in one of the embedded slots 223. The press piece 511 has an outside with a smooth face and an inside with a radian corresponding to that of the push member 52 (or the mounting portion 522). The two springs 513 are mounted on two ends of the press piece 511. The two fastening members 512 extend through the two springs 513 and the press piece 511 and are secured to one of the embedded slots 223. Thus, the press piece 511 is pushed by an elastic force of the two springs 513 to move elastically and reciprocally in one of the embedded slots 223 so that the press piece 511 is served as an elastic locking hook.

In the preferred embodiment of the present invention, the stop portion 521 of the push member 52 has an oblique conic face. The mounting portion 522 has a smooth annular face having a diameter less than that of the stop portion 521.

In the preferred embodiment of the present invention, the stop portion 521 is formed on the top of the push member 52, and the mounting portion 522 extends downward from the stop portion 521.

In the preferred embodiment of the present invention, the second locking portion 523 of the push member 52 is an internal thread, and the first locking portion 313 of the filter bottle 31 is an external thread.

In the preferred embodiment of the present invention, the snap-fit member 53 is provided with two opposite oblique conic faces formed on a top and a bottom thereof. Thus, the snap-fit member 53 is movable on and presses t he movable modules 51 by guidance of the two opposite oblique conic faces so that the snap-fit member 53 and the movable modules 51 are alternatingly misaligned up and down.

In the preferred embodiment of the present invention, the first end 21 has an exterior provided with a water inlet connector 213 connected to the water inlet 211 and a water outlet connector 214 connected to the water outlet 212.

In the preferred embodiment of the present invention, the first end 21 of the filtering head 20 is provided with a through hole 221 for mounting the handle 41 which protrude from the through hole 221.

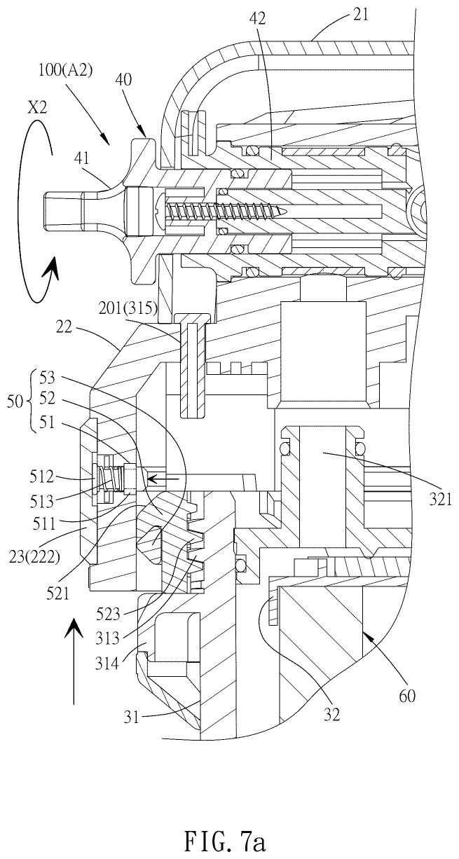

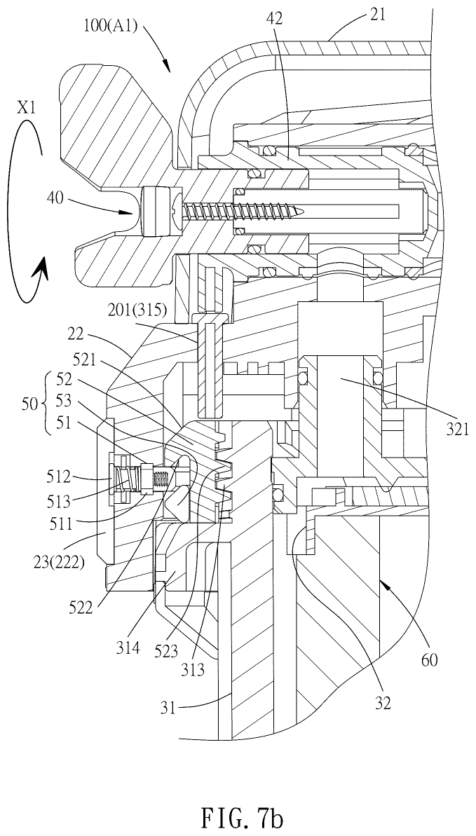

Referring to FIGS. 7a and 7b with reference to FIGS. 1-6, when the handle 41 of the switching device 40 is rotated to the second positioning direction X2, the control shaft 42 is rotated to reach the by-pass mode A2, so that the connecting hole 421 of the control shaft 42 is disconnected from the flow channel 321. In assembly, when the filter bottle 31 is pushed toward the filtering head 20, the stop portion 521 of the push member 52 presses the movable modules 51 to move in the embedded slots 223 as shown in FIG. 7a, so that the press piece 511 of each of the movable modules 51 is retracted into one of the embedded slots 223. After the stop portion 521 of the push member 52 passes through and is located above the movable modules 51, the press piece 511 of each of the movable modules 51 is pushed outward by the elastic force of the two springs 513, so that the movable modules 51 are moved to protrude from the embedded slots 223. At this time, the movable modules 51 are clamped and positioned between the stop portion 521 of the push member 52 and the snap-fit member 53 as shown in FIG. 7b to form a locking state therebetween, so that the filter bottle 31 is locked on the filtering head 20. Thus, the filter bottle assembly 30 is assembled with the filtering head 20. In addition, when the filter bottle assembly 30 is assembled with the filtering head 20, the second end 22 of the filtering head 20 is mounted on the stop block 314 of the filter bottle 31. Then, the handle 41 of the switching device 40 is rotated to the first positioning direction X1, and the control shaft 42 is rotated to reach the water purifying mode A1.

In use, when the control shaft 42 is rotated to reach the water purifying mode A1, the connecting hole 421 of the control shaft 42 is connected to the water inlet 211 and the water outlet 212, and is connected to the flow channel 321, so that the ambient water flows through the water inlet 211, the connecting hole 421 and the flow channel 321 into the filter element 60 which strains the water. Then, the purified water from the filter element 60 flows through the flow channel 321 and the connecting hole 421 into the water outlet 212 and flows outward from the water outlet 212.

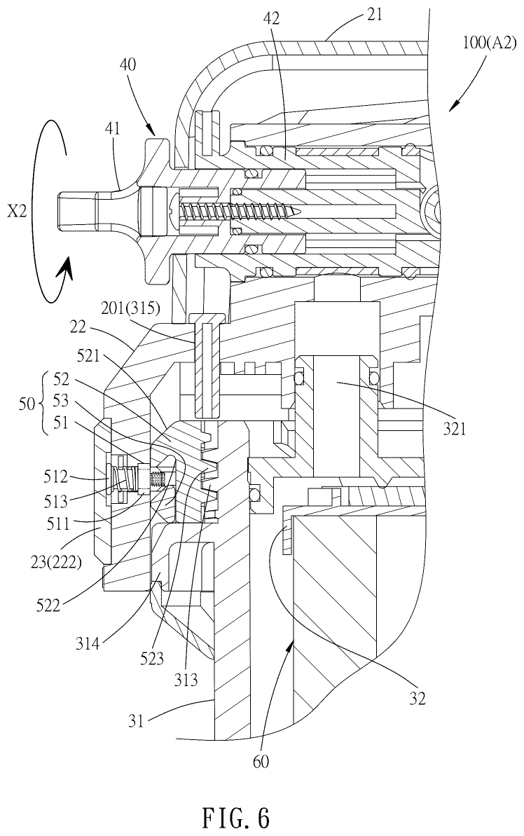

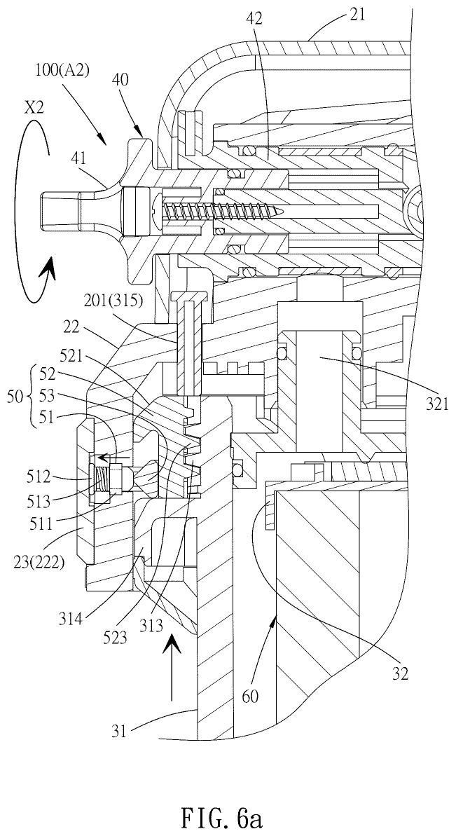

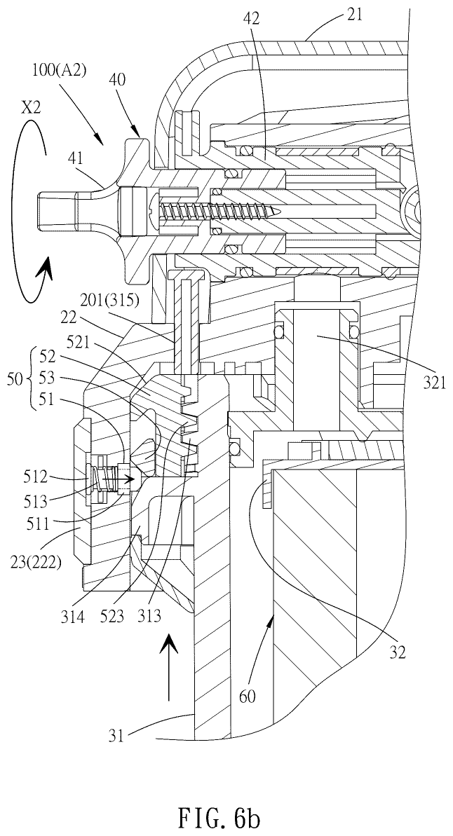

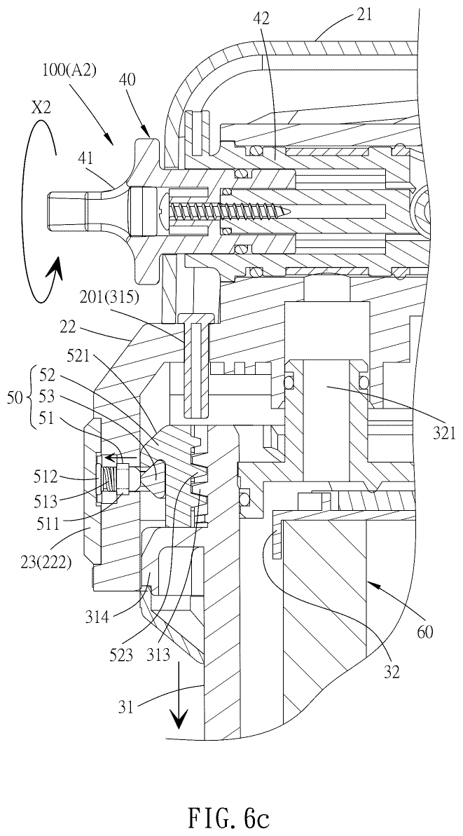

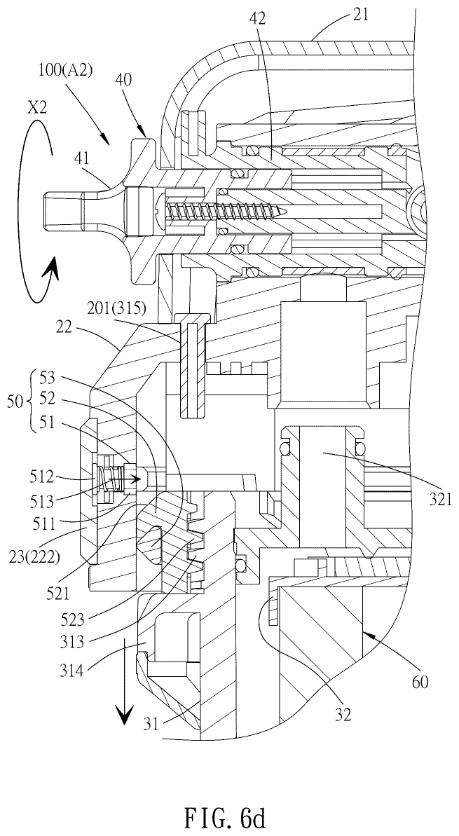

Referring to FIGS. 6a, 6b, 6c, and 6d with reference to FIGS. 1-6, when the handle 41 of the switching device 40 is rotated to the second positioning direction X2, the control shaft 42 is rotated to reach the by-pass mode A2, so that the connecting hole 421 of the control shaft 42 is disconnected from the flow channel 321, and the ambient water directly flows through the water inlet 211 into the water outlet 212. Then, the pressure relief valve 70 is pressed to release the pressure in the filter bottle 31 to facilitate replacement of the filter bottle 31.

In replacement, the stop portion 521 of the push member 52 is initially located above the movable modules 51 as shown in FIG. 6. Then, the filter bottle 31 is pushed upward so that the snap-fit member 53 presses the movable modules 51 to retract elastically as shown in FIG. 6a. When the filter bottle 31 is pushed upward to reach the top point, the stop portion 521 of the push member 52 and the snap-fit member 53 are located above the movable modules 51 as shown in FIG. 6b, and when the filter bottle 31 is quickly pulled downward after the filter bottle 31 reaches the top point, the stop portion 521 of the push member 52 and the snap-fit member 53 are moved downward simultaneously to press and pass the movable modules 51 as shown in FIG. 6c, to release the locking state therebetween. After the stop portion 521 of the push member 52 and the snap-fit member 53 are located under and detached from the movable modules 51 as shown in FIG. 6d, the filter bottle 31 is unlocked and removed from the filtering head 20. In conclusion, when the filter bottle 31 is pushed upward to reach the top point and is then pulled downward quickly, the filter bottle 31 is directly unlocked from the filtering head 20, so that the filter bottle 31 is removed from the filtering head 20.

Accordingly, when the filter bottle 31 is pushed toward the filtering head 20, the filter bottle 31 is directly locked on the filtering head 20, and when the filter bottle 31 is pushed upward to reach the top point and is then pulled downward quickly, the filter bottle 31 is directly unlocked from the filtering head 20, so that the filter bottle 31 is assembled with and disassembled from the filtering head 20 easily and rapidly. In addition, the user directly assembles and disassembles the filter bottle 31 without having to prepare any tool, thereby facilitating the user assembling and disassembling the filter bottle 31. Further, when the indication line 412 and the connecting hole 421 are directed in the longitudinal and vertical direction, the switching device 40 is switched to the water purifying mode A1, and when the indication line 412 and the connecting hole 421 are directed in the transverse and horizontal direction, the switching device 40 is switched to the by-pass mode A2, so that the user can identify the water inlet modes easily without having to turn on/off the switch of the water source. Further, the indication line 412 is directly formed on the handle 41 without having to print an indication mark on the filtering head 20. Further, the user has to hold the filter bottle 31 during the assembling and disassembling process so that the filter bottle 31 will not fall down unintentionally.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A water filter comprising:
a filtering head, a filter bottle assembly, a filter element, a switching device, and a quick release device;
wherein:
the filtering head has a first end and a second end;
the first end is provided with a water inlet and a water outlet connected to the water inlet;
the second end is provided with multiple embedded slots;
the filter bottle assembly includes a filter bottle removably mounted on a lower portion of the filtering head;
the filter bottle has an upper end provided with a first locking portion and a stop block located under the first locking portion;
the stop block rests on the second end;
the filter element is mounted in the filter bottle and provided with a flow channel;
the switching device is mounted on the first end of the filtering head;
the switching device includes a handle and a control shaft connected with the handle;
the control shaft is provided with a connecting hole which is a valve port penetrating the control shaft;
the control shaft is rotated with the handle synchronously;
the control shaft and the handle are rotated in the same direction;
the quick release device includes multiple movable modules, a push member, and a snap-fit member;
the movable modules are mounted in the embedded slots respectively;
the movable modules elastically extend into and are reciprocally moved in the embedded slots;
the push member has an exterior provided with a stop portion and a mounting portion;
the mounting portion is a mounting ring;
the push member has an interior provided with a second locking portion locked onto the first locking portion of the filter bottle;
the snap-fit member is slidably mounted on the mounting portion and is spaced from the stop portion;
when the handle is rotated, the control shaft is rotated between a water purifying mode and a by-pass mode;
when the control shaft is rotated to the water purifying mode, the connecting hole of the control shaft is connected to the water inlet and the water outlet, and is connected to the flow channel;
when the control shaft is rotated to the by-pass mode, the connecting hole of the control shaft is connected to the water inlet and the water outlet, and is disconnected from the flow channel;
when the filter bottle is pushed up, the push member is moved to press the movable modules;
when the push member is located above the movable modules, the movable modules are positioned between the stop portion of the push member and the snap-fit member to form a locking state therebetween, so that the filter bottle is locked on the filtering head;
when the filter bottle is pushed upward to reach a top point, the snap-fit member is located above the movable modules; and
when the filter bottle is quickly pulled downward after the filter bottle reaches the top point, the stop portion of the push member and the snap-fit member are moved downward simultaneously to press and pass the movable modules, so that the filter bottle is unlocked and removed from the filtering head.

2. The water filter as claimed in claim 1, wherein a mounting bracket is mounted on a rear side of the first end of the filtering head to hang the water filter.

3. The water filter as claimed in claim 1, wherein:
the second end of the filtering head has an area more than that of the first end so that the filtering head has a stepped shape;
the second end of the filtering head has an exterior provided with a mounting groove; and
a protection cover is mounted in the mounting groove.

4. The water filter as claimed in claim 1, wherein:
the filter bottle assembly further includes a first positioning plate mounted in the filter bottle, and a second positioning plate mounted in the filter bottle;
the filter bottle has a first receiving space defined between the first positioning plate and the second positioning plate and a second receiving space defined between the second positioning plate and a bottom of the filter bottle;
the filter element is received in the first receiving space; and
a pressure relief valve is mounted on the bottom of the filter bottle and connected to the second receiving space.

5. The water filter as claimed in claim 1, wherein:
the upper end of the filter bottle has an interior provided with at least one gap;
a press rod is mounted on the second end of the filtering head and is movable to extend into the at least one gap;
the press rod is disposed under the switching device; and
when the switching device is rotated, the press rod is pressed downward by the handle and extends into the at least one gap to press the filter bottle, and to provide a downward force to aid replacement of the filter bottle.

6. The water filter as claimed in claim 1, wherein the switching device further includes a ratchet mechanism connected with the control shaft and has an oblique toothed face, and a drive lever mounted on the first end of the filtering head and meshing with the ratchet mechanism to form a one-way rotation of the control shaft.

7. The water filter as claimed in claim 1, wherein:
the handle is provided with an indication line;
the indication line and the connecting hole of the control shaft are directed in the same direction. the handle of the switching device is moved between a first positioning direction where the indication line and the connecting hole are directed in a longitudinal and vertical direction and a second positioning direction where the indication line and the connecting hole are directed in a transverse and horizontal direction;
when the handle of the switching device is moved to the first positioning direction, the control shaft is rotated to reach the water purifying mode; and
when the handle of the switching device is moved to the second positioning direction, the control shaft is rotated to reach the by-pass mode.

8. The water filter as claimed in claim 1, wherein:
each of the movable modules includes a press piece, two springs, and two fastening members;
the press piece is movably mounted in one of the embedded slots;
the press piece has an outside with a smooth face and an inside with a radian corresponding to that of the push member;
the two springs are mounted on two ends of the press piece;
the two fastening members extend through the two springs and the press piece and are secured to one of the embedded slots; and
the press piece is pushed by an elastic force of the two springs to move elastically and reciprocally in one of the embedded slots so that the press piece is served as an elastic locking hook.

9. The water filter as claimed in claim 1, wherein the stop portion of the push member has an oblique conic face, and the mounting portion has a smooth annular face having a diameter less than that of the stop portion.

10. The water filter as claimed in claim 1, wherein the snap-fit member is provided with two opposite oblique conic faces formed on a top and a bottom thereof, and the snap-fit member is movable on and presses the movable modules by guidance of the two opposite oblique conic faces so that the snap-fit member and the movable modules are alternatingly misaligned up and down.
